(19) United States
(12) Patent Application Publication
(10) Pub. No.: US 2010/0018999 A1
(43) Pub. Date: Jan. 28, 2010

(54) DISPENSING DEVICE CONSISTING OF A CONTAINER WITH A NECK AND A DISPENSING HEAD CONNECTED THERETO BY A SNAP-COUPLING

(76) Inventors: Wilhelmus Johannes Joseph Maas, Someren (NL); Petrus Lambertus Wilhelmus Hurkmans, Someren (NL)

Correspondence Address: HARNESS, DICKEY & PIERCE, P.L.C., P.O. BOX 8910, RESTON, VA, 20195, US

(21) Appl. No.: 12/448,132

(22) PCT Filed: Dec. 20, 2007
(86) PCT No.: PCT/NL2007/000322

§ 371 Date: Sep. 30, 2009

(30) Foreign Application Priority Data
Dec. 29, 2006 (NL) 1033149

(51) Int. Cl. B67D 7/58

(52) U.S. Cl. 222/383.1

(57) ABSTRACT

One embodiment of the present invention relates to a dispensing device including a container with a neck and a dispensing head connected to the neck, wherein the neck and the head have co-acting snap-coupling devices which include at least three protrusions arranged on one of the two components for connecting, and at least one edge which is arranged on the other part and which co-acts with the protrusions. According to one embodiment of the present invention, the protrusions are herein distributed non-uniformly as seen in peripheral direction of the neck. Two of the three protrusions can particularly have a substantially equal distance relative to the third protrusion, this distance being greater than their mutual distance. The edge can be divided into a number of edge segments corresponding to the number of protrusions, wherein the edge segments co-acting with the two protrusions located at equal distances relative to the third protrusion can each form part of a boundary of a recess receiving the associated protrusion.

The invention relates to a dispensing device comprising a container with a neck and a dispensing head connected to the neck, wherein the neck and the head have co-acting snap-coupling means which comprise at least three protrusions arranged on one of the two components for connecting, and at least one edge which is arranged on the other part and which co-acts with the protrusions. Such a dispensing device is known from the earlier patent application WO 02/42006 of applicant, and is for instance applied for liquid cleaning agents.

Dispensing devices of this type consist of a bottle with a neck to which a dispensing head, generally a spray head, is attached. In conventional designs the neck of the bottle was herein provided on its outer periphery with screw thread, while the dispensing head had a skirt with internal screw thread fitting round this neck.

The conventional dispensing device had the drawback that a screwing movement had to be carried out to attach the spray head to the bottle, i.e. the spray head, or at least a part thereof, and the bottle had to be rotated around their axes relative to each other a number of times. This was a particular drawback during the filling of the dispensing device, which was performed by machine in an industrial filling line. Throughput speed is of great importance here, and this throughput speed was adversely affected by the required screwing movement.

A dispensing device of this type in which this drawback no longer occurs has therefore already been described in the above stated patent application WO 02/42006. It is proposed for this purpose in this older patent application to provide the neck of the container and the head with co-acting snap-coupling means in the form of three protrusions on the inner side of the dispensing head and three recesses in the neck. By thus being able to snap the dispensing head onto the container instead of having to screw it, the connection between the dispensing head and the container can be effected more quickly and easily, whereby the speed of an automatic filling line where this operation takes place can be increased. Furthermore, the recesses are provided on their sides with upward sloping guide surfaces, whereby the dispensing head can not only be snapped onto the container but can also be connected thereto by means of a combined pressing and turning movement in the form of a bayonet fitting.

In the known dispensing device a connection which can be effected rapidly but still seals properly is formed in that one of the protrusions is relatively stiff and non-deformable, while the other protrusions are more flexible. This is achieved in this dispensing device, which is manufactured from a relatively stiff plastic such as PET, in that the vicinity of the flexible protrusions is weakened locally by arranging incisions. Such incisions are not only unsightly but also require expensive modifications to the moulds in which the components of the dispensing device are formed. In addition, they result in design problems as a result of the fundamental local change in the material properties.

The invention therefore has for its object to improve a dispensing device of the above described type such that these drawbacks do not occur, or at least do so to a lesser extent. According to the invention this is achieved in such a dispensing device in that the protrusions are distributed non-uniformly as seen in peripheral direction of the neck. The effect of this uneven distribution is that the force required to snap the protrusions of the one component fixedly onto the edge of the other component varies from protrusion to protrusion, since the moment arm—as calculated from the other protrusions, which function as fixed point in snapping of the final protrusion—differs in each case. The clamping force, and thereby the sealing, can thus be adjusted by a suitable design and a suitably chosen placing of the protrusions.

A simple design with readily adjustable properties is obtained when two of the three protrusions have a substantially equal distance relative to the third protrusion, this distance being greater than their mutual distance. One of the protrusions thus has different clamping properties compared to the other two.

With a view to proper distribution of the clamping forces and the ability to manufacture the dispensing device in an injection moulding process, the two protrusions can be offset over 50 to 110 degrees relative to each other and over 125 to 155 degrees relative to the third protrusion. The two protrusions are preferably offset over 70 to 100 degrees relative to each other and over 130 to 145 degrees relative to the third protrusion, and most preferably they are offset over substantially 90 degrees relative to each other and over substantially 135 degrees relative to the third protrusion.

When the dispensing head has a spray nozzle, it is recommended from the viewpoint of the assembly of the dispensing device that the third protrusion is situated on the side of the spray nozzle and the two other protrusions are arranged on the side remote from the spray nozzle.

When the dispensing head has a centre line running through the spray nozzle, the third protrusion is preferably located on the centre line while the other two protrusions are then arranged symmetrically relative to the centre line. An optimal distribution of the clamping forces is thus achieved.

Although a dispensing device is obtained which is very simple to produce when the edge is formed as a continuous whole, it is nevertheless recommended that the edge is divided into a number of edge segments corresponding to the number of protrusions. The edge segments co-acting with the two protrusions located at equal distances relative to the third protrusion herein advantageously each form part of a boundary of a recess receiving the associated protrusion. Not only is a very good attachment of the dispensing head to the container hereby obtained, but other connection options also result.

When the or each recess has on at least two sides a guide surface co-acting with the corresponding protrusion and sloping in the connecting direction, the dispensing head can not only be snapped onto the container but can also be connected thereto by means of a combined pressing and turning movement in the form of a bayonet fitting. The guide surfaces can of course also be arranged on the protrusions.

An easily realized yet firm connection is obtained when at least the protrusions and the edge or edge segments are manufactured from a plastic. Suitable plastics, from a viewpoint of technical properties as well as availability and cost price, are for instance polyethylene or polypropylene.

From considerations of production engineering it is recommended that the protrusions are arranged on the dispensing head and the edge or edge segments on the neck of the container.

The invention further relates to a dispensing head and a container with a neck which are evidently intended for application in a dispensing device as described above.

The invention is now elucidated on the basis of an example, wherein reference is made to the accompanying drawing, in which:

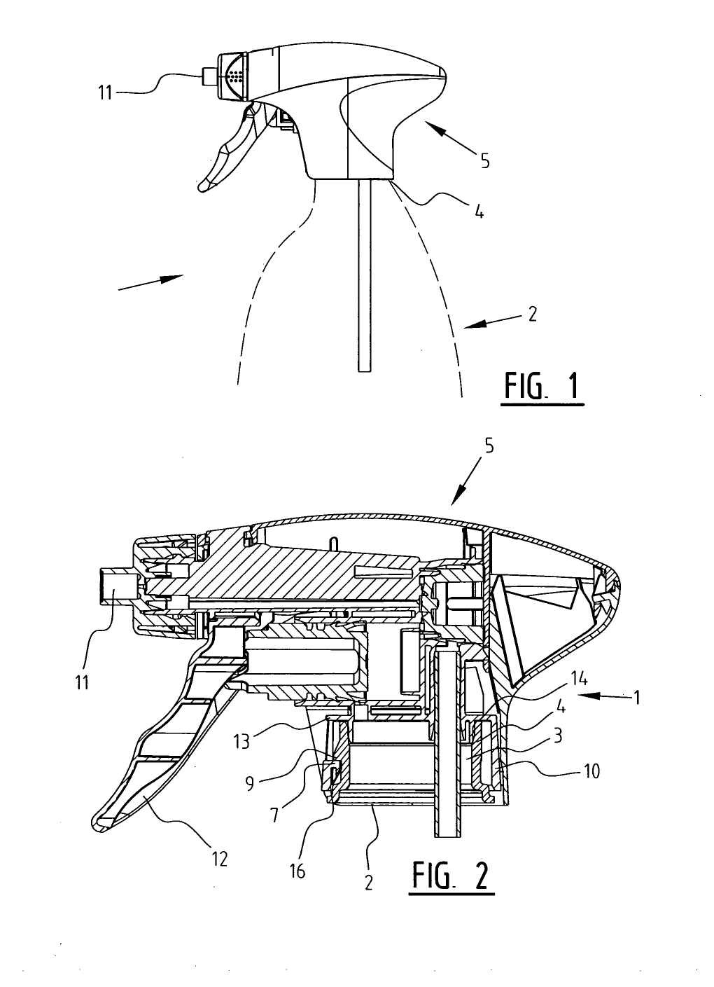

FIG. 1 is a side view of a dispensing device according to the invention, consisting of a container and a dispensing head fastened thereon, in the assembled situation,

FIG. 2 is a cross-section on an enlarged scale through the dispensing head and the upper part of the container of FIG. 1,

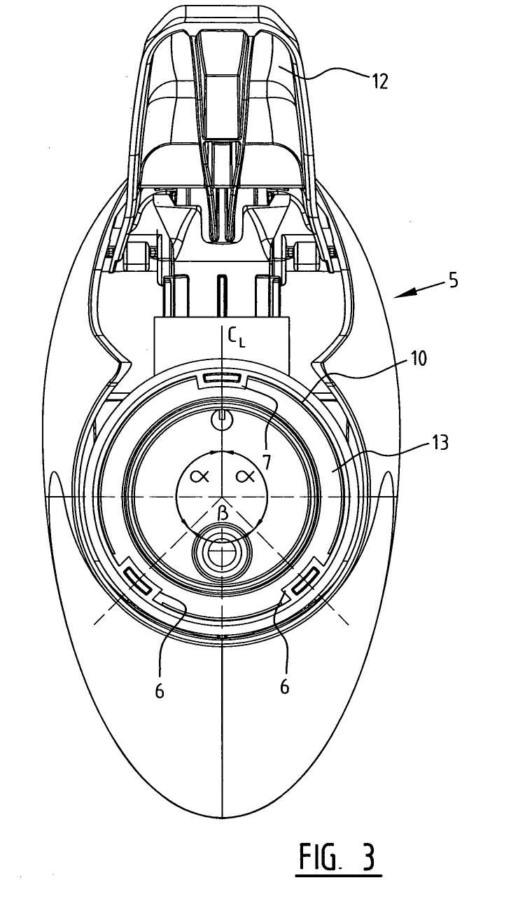

FIG. 3 is a bottom view of the dispensing head of FIG. 2,

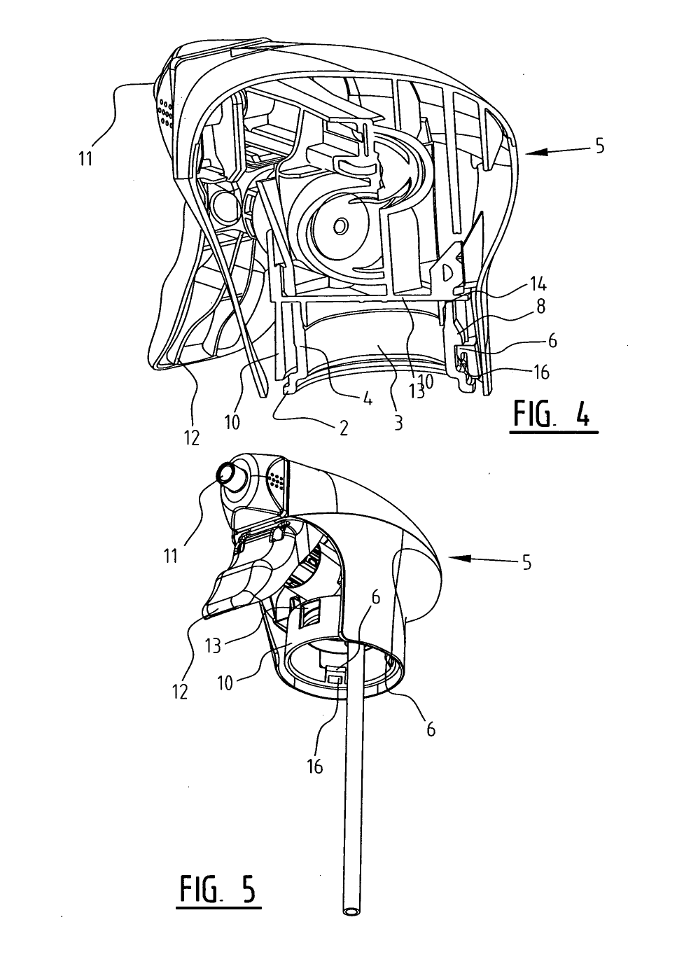

FIG. 4 is a cross-section through the dispensing head and the upper part of the container along line IV-IV in FIG. 3,

FIG. 5 is a perspective bottom view of the dispensing head,

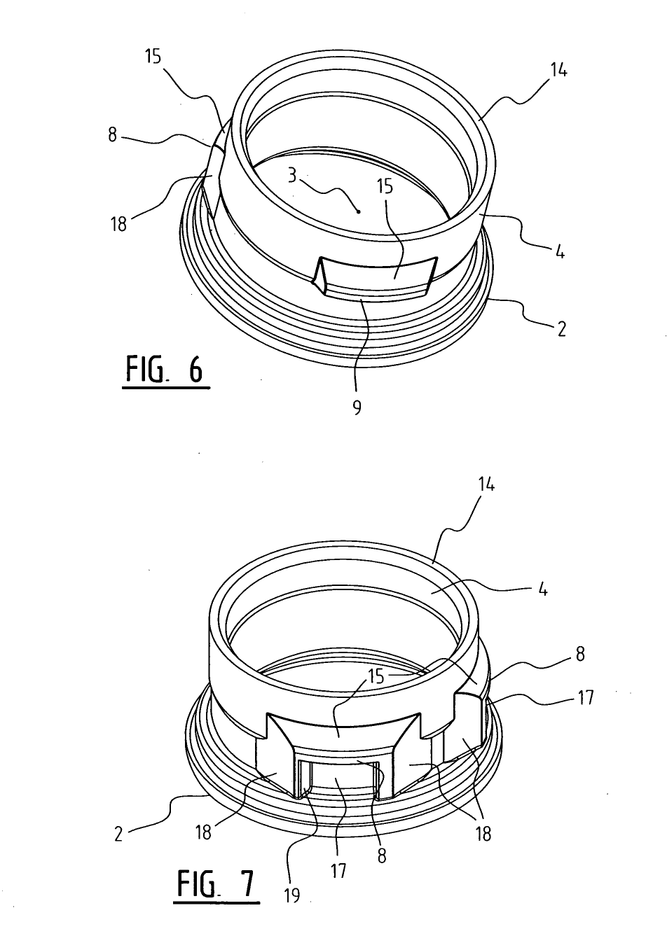

FIG. 6 and FIG. 7 are perspective top views of the neck of the container from respectively the front and the rear,

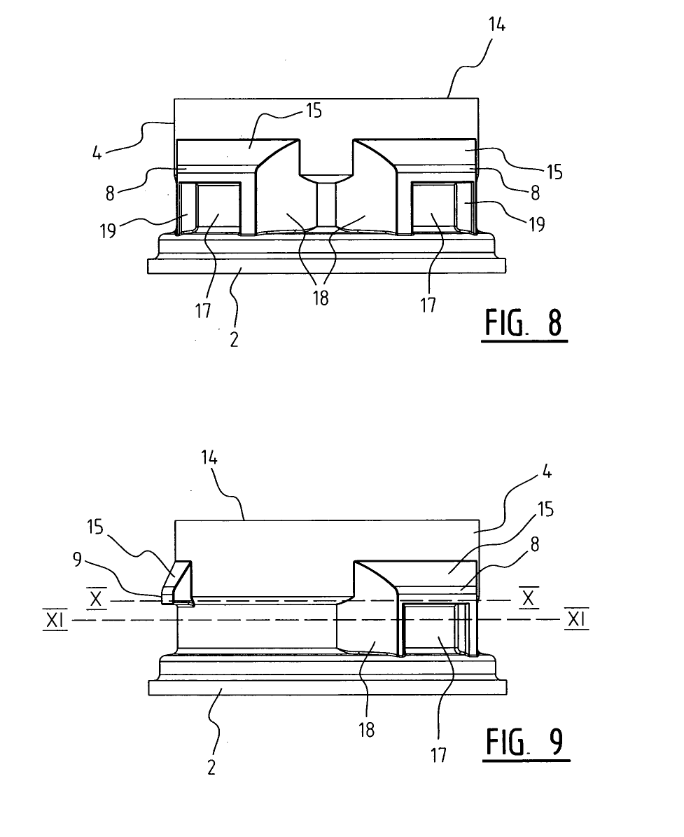

FIG. 8 and FIG. 9 show respectively a rear view and a side view of the neck of the container, and

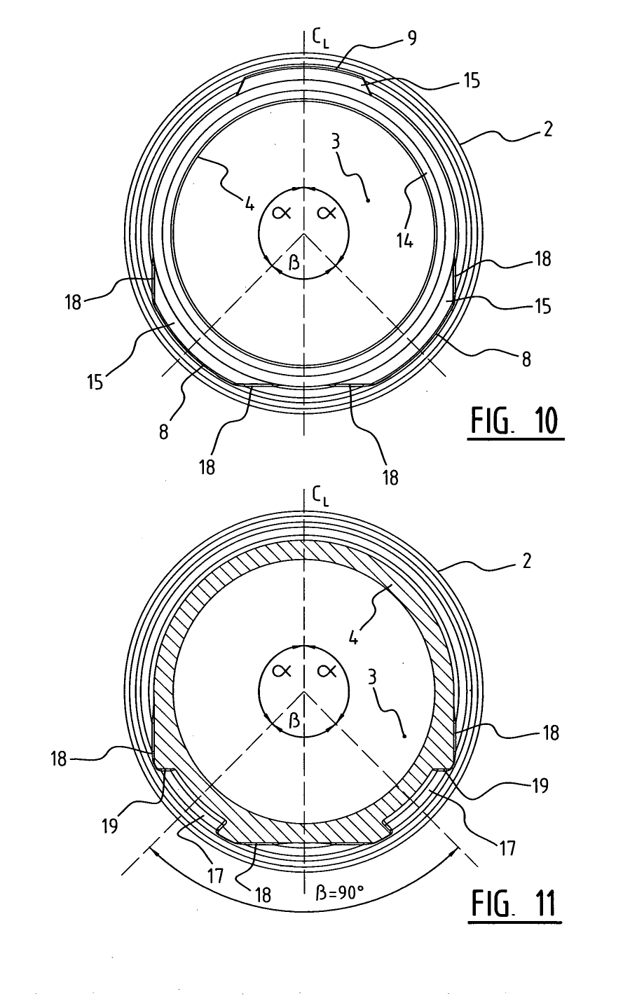

FIG. 10 and FIG. 11 show cross-sections through the neck of the container respectively along line X-X and line XI-XI in FIG. 9.

A dispensing device 1 (FIG. 1) consists of a container 2 (shown schematically here) with a filling and outflow opening 3 on the top side. This opening 3 is bounded by a neck 4 on which a dispensing head 5 is fastened. The internal structure and the operation of dispensing head 5 do not form part of the invention, so they will not be described here in detail.

For their mutual attachment neck 4 of container 2 and dispensing head 5 are each provided with co-acting snap-coupling means in the form of a number of protrusions 6, 7 and edge segments 8, 9 co-acting with the protrusions. Protrusions 6, 7 are here arranged on the inner side of a skirt 10 on the underside of dispensing head 5, while edge segments 8, 9 are arranged on the outer side of neck 4.

According to the invention the three protrusions 6, 7 are arranged in non-uniform distribution as seen in the peripheral direction of neck 4. Two protrusions 6 are here placed relatively close to each other, while third protrusion 7 is arranged at a relatively greater distance from the other two protrusions 6. The moment arm, which is determined by the distance between each individual protrusion and the two other protrusions, which do after all function as fixed points during snapping of the final protrusion, is hereby greater for the third protrusion 7 than for the two other protrusions 6. Greater forces can thus be overcome at the position of the third protrusion 7 during the snapping.

In the shown example third protrusion 7 is placed centrally, on centre line C_{L} of dispensing head 5, while the other two protrusions 6 are arranged symmetrically relative to this centre line C_{L}. They are therefore each the same distance from the central or third protrusion 7. The central or third protrusion 7 is placed here on the front side, so on the side of dispensing head 5 where spray nozzle 11 protrudes and where trigger 12 is pivotally mounted. This is the side where the loads are lowest, so that the risk of the central protrusion 7 inadvertently being released is limited.

The optimal distance between the different protrusions 6, 7 will of course depend on different factors, such as the expected loads and deformations, the desired clamping force and desired degree of sealing, the materials used and material thicknesses chosen and the like. It is also important that dispensing head 5 and container 2 can be manufactured at relatively low cost in an injection moulding process or a blow moulding process. The chosen configuration must therefore be such that it can be formed using relatively simple moulds. It has been found that these requirements can be met when the angle α over which the second protrusions 6 are offset relative to third protrusion 7 lies between 125 and 155 degrees, wherein the angle β over which the second protrusions 6 are offset relative to each other lies between 50 and 110 degrees. The angle α can more particularly lie between 130 and 145 degrees and angle β between 70 and 100 degrees. In the shown embodiment the angle α amounts to about 135 degrees and the angle β to about 90 degrees (FIG. 3).

In order to fasten dispensing head 5 in stable manner on neck 4 of container 2, this head otherwise rests with a support surface 13 on upper edge 14 of neck 4 (FIG. 2, 4).

The three edge segments 8, 9 each have a chamfered upper surface 15, whereby protrusions 6, 7, which each have a chamfered lower surface 16, are urged outward when dispensing head 5 is pressed onto container 2. Protrusions 6, 7 can thus be snapped over these edge segments 8, 9 with relatively little effort, while a very firm connection is nevertheless formed between dispensing head 5 and container 2.

Edge segments 8 otherwise each form part of the boundary of a recess 17 in which the corresponding protrusion 6 is accommodated. Each recess 17 is further bounded on either side by guide surfaces 18 (FIG. 10, 11), which slope upward in the connecting direction, i.e. the direction in which dispensing head 5 and container 2 are fastened to each other. Protrusions 6 can hereby also be inserted into recesses 17 from this side when dispensing head 5 is fastened on container 2 by means of a turning movement, with forming of a bayonet fitting.

In order to enable refilling of container 2, dispensing head 5 can-be fastened releasably to neck 4. In the shown example the recesses 17 are for this purpose each provided on one side with a guide surface 19 which slopes in a direction opposite the connecting direction.

When it is undesirable that dispensing head 5 can be released from container 2, straight, upright surfaces can also be formed along recesses 17, whereby protrusions 6 are held fast therein.

As an intermediate form it is possible to envisage embodying the side walls of recesses 17 such that protrusions 6 can only be disengaged from recesses 17 with an extra operation, for instance partially squeezing and simultaneously rotating skirt 10. A childproof fastening is thus achieved.

Container 2 and dispensing head 5 can in principle be manufactured from any suitable material, in particular from any suitable plastic. In the shown preferred embodiment container 2 and dispensing head 5 are manufactured from polypropylene or polyethylene. These plastics are highly suitable for large-scale manufacturing processes such as blow moulding and injection moulding, are sufficiently strong and resilient and can be readily recycled.

Filling and assembly of dispensing device 1 according to the invention takes place as follows. Container 2 is supplied empty and filled with the medium for dispensing in a filling station. At a subsequent station the dispensing head 5 is supplied and pressed onto neck 4 of container 2. Dispensing head 5 and container 2 are herein oriented such that protrusions 6,7 and edge segments 8,9 lie precisely in register. Dispensing head 5 is thus snapped onto neck 4 of container 2.

When recesses 17 also have guide surfaces 18 along their edge running in the connecting direction, as in the shown example, dispensing head 5 can also be fastened on container 2 by means of a combined pressing and turning movement with the forming of a bayonet fitting.

Because recesses 17 are also provided in the shown example with a guide surface 19, which slopes in a direction opposite the connecting direction, the formed snap or bayonet connection can also be released, for instance in order to refill container 2.

Although the invention is elucidated above on the basis of an embodiment, it will be apparent that it is not limited thereto. More than three protrusions and edge segments could for instance be present, while relative positions of the different protrusions could also be varied. The position of the protrusions and edge segments could further also be reversed, i.e. with protrusions on the neck of the container and edge segments on the dispensing head. The guide surfaces could also be formed on the protrusions instead of on the edges of the recesses. Finally, it is also possible to envisage applying a single continuous edge instead of separate edge segments.

The scope of the invention is therefore defined solely by the appended claims.

1. Dispensing device, comprising:
a container including a neck and a dispensing head connected to the neck, the neck and the dispensing head including co-acting snap-coupling components, at least one of the co-acting snap-coupling components including at least three protrusions distributed non-uniformly in a peripheral direction of the neck and at least one other of the co-acting snap-coupling components including at least one edge which co-acts with the at least three protrusions.

2. Dispensing device as claimed in claim 1, wherein two of the three at least three protrusions have a substantially equal distance relative to the third protrusion, the substantially equal distance being greater than distance between the two protrusions.

3. Dispensing device as claimed in claim 2, wherein the two protrusions are offset over 50 to 110 degrees relative to each other and over 125 to 155 degrees relative to the third protrusion.

4. Dispensing device as claimed in claim 3, wherein the two protrusions are offset over 70 to 100 degrees relative to each other and over 130 to 145 degrees relative to the third protrusion.

5. Dispensing device as claimed in claim 4, wherein the two protrusions are offset over substantially 90 degrees relative to each other and over substantially 135 degrees relative to the third protrusion.

6. Dispensing device as claimed in claim 2, wherein the dispensing head includes a spray nozzle, a third protrusion of the at least three protrusions is situated on a side of the spray nozzle and the two protrusions are arranged on a side remote from the spray nozzle.

7. Dispensing device as claimed in claim 6, wherein: the dispensing head includes a center line running through the spray nozzle, the third protrusion is located on the centre line and the two protrusions are arranged symmetrically relative to the center line.

8. Dispensing device as claimed in claim 1, wherein the edge is divided into a number of edge segments corresponding to the number of protrusions.

9. Dispensing device as claimed in claims 2, wherein the edge segments, co-acting with the two protrusions located at equal distances relative to the third protrusion, each form part of a boundary of a recess receiving the associated protrusion.

10. Dispensing device as claimed in claim 9, wherein at least one recess includes, on at least two sides, a guide surface co-acting with a corresponding one of the at least three protrusions and sloping in a connecting direction.

11. Dispensing device as claimed in claim 1, wherein at least the at least three protrusions and the at least one edge are manufactured from a plastic.

12. Dispensing device as claimed in claim 1, wherein the at least three protrusions are arranged on the dispensing head and the at least one edge on the neck of the container.

13. Dispensing head, for application in a dispensing device as claimed in claim 1.

14. Container with a neck, for application in a dispensing device as claimed in claim 1.

15. Dispensing device as claimed in claim 3, wherein the dispensing head includes a spray nozzle, a third protrusion of the at least three protrusions is situated on a side of the spray nozzle and the two protrusions are arranged on a side remote from the spray nozzle.

16. Dispensing device as claimed in claim 4, wherein the dispensing head includes a spray nozzle, a third protrusion of the at least three protrusions is situated on a side of the spray nozzle and the two protrusions are arranged on a side remote from the spray nozzle.

17. Dispensing device as claimed in claim 5, wherein the dispensing head includes a spray nozzle, a third protrusion of the at least three protrusions is situated on a side of the spray nozzle and the two protrusions are arranged on a side remote from the spray nozzle.

18. A dispensing head, connected to a neck of a dispensing device, the neck and the dispensing head including co-acting snap-coupling components, at least one of the co-acting snap-coupling components including at least three protrusions distributed non-uniformly in a peripheral direction of the neck and at least one other of the co-acting snap-coupling components including at least one edge which co-acts with the at least three protrusions.

19. A neck, connected to and a dispensing head of a dispensing device, the neck and the dispensing head including co-acting snap-coupling components, at least one of the co-acting snap-coupling components including at least three protrusions distributed non-uniformly in a peripheral direction of the neck and at least one other of the co-acting snap-coupling components including at least one edge which co-acts with the at least three protrusions.
